(19) United States
(12) Patent Application Publication
(10) Pub. No.: US 2008/0197235 A1
(43) Pub. Date: Aug. 21, 2008

(54) Technique for preventing the thermal insulating foam falling off the space shuttle and its external tank (ET)

(76) Inventor: Yixin Guo, Ronkonkoma, NY (US)

Correspondence Address: Yixin Guo, 256 Holbrook Ave., Ronkonkoma, NY, 11779, US

(21) Appl. No.: 11/706,162

(22) Filed: Feb. 15, 2007

(51) Int. Cl. B64C 1/00

(52) U.S. Cl. 244/119

(57) ABSTRACT

The invention as disclosed herein is a technique for preventing the thermal insulating foam from peeling off from the space shuttle and its external tank (ET) possessing the following characteristics: a high intensity protective net shield designed for the space shuttle or/and the ET, which is made of the high-temperature and high intensity ropes, is installed as one of the following designs: A. Install the protective net shield directly on the out side of the thermal insulating foam of the space shuttle and its ET by covering the thermal insulating foam while the mesh area of the protective net shield is smaller than the area of the single thermal insulating foam chunk so that it would prevent the thermal insulating foam chunks falling out from the mesh, and fix the mesh knots onto corresponding thermal insulating foam chunks; B. Between joint lines of two adjacent polygon thermal insulating foam chunks of the space shuttle and its ET, respectively bind two thermal insulating foam chunks together with a rope through the meshes, and the binding ropes creates at least one binding loop at each joint line; then connect all binding loops of each joint lines of each corresponding thermal insulating foam chunk into a protective loop by the ropes. Connect each protective loop via each binding loop as mesh knots, and thereby form the protective net shield. This invention is practical and easy to operate, which will effectively prevent the thermal insulating foam from peeling off and resolve the safety problem resulted from the peeling off of the thermal insulating foam from the space shuttle and its ET.

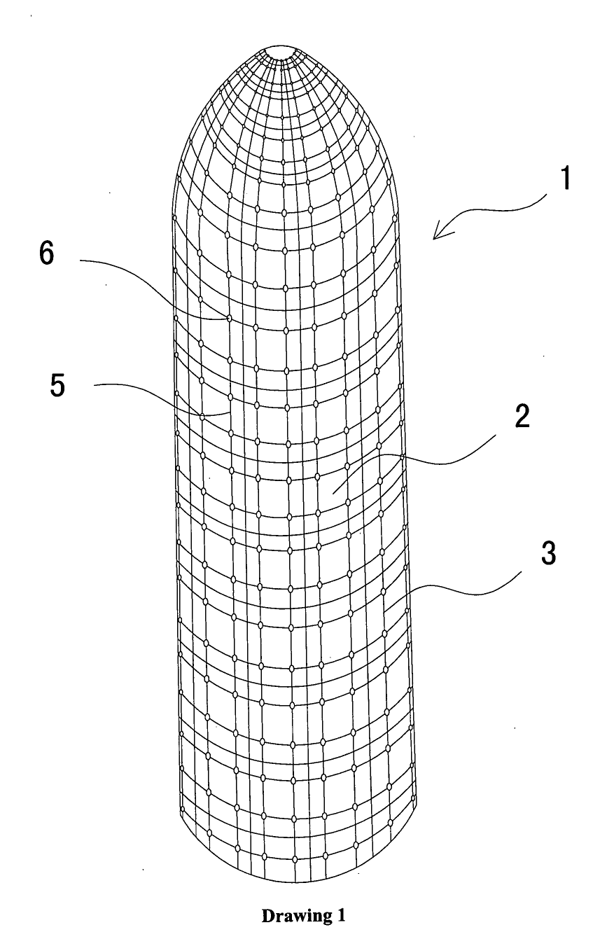

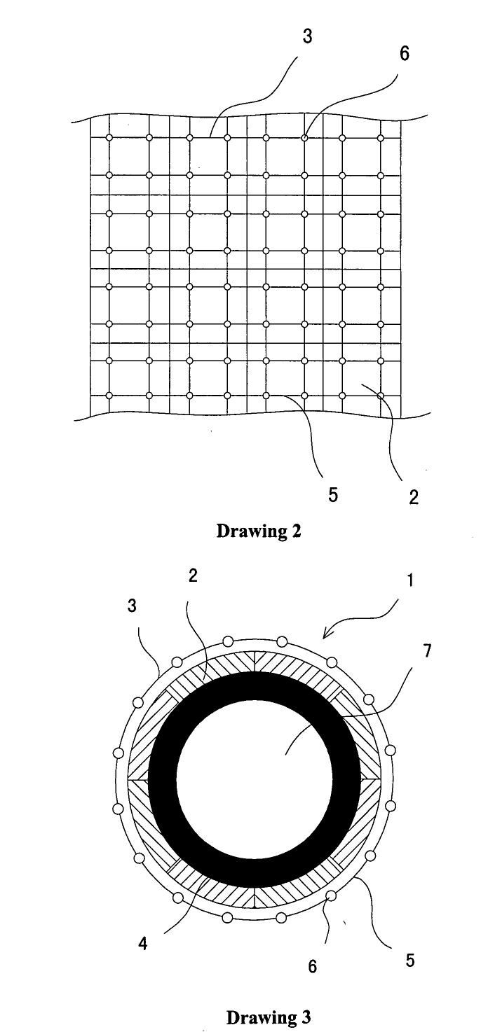

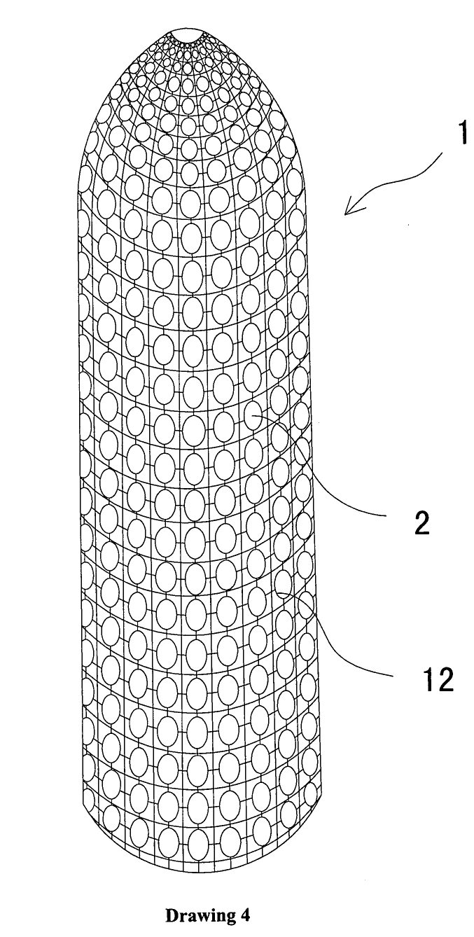

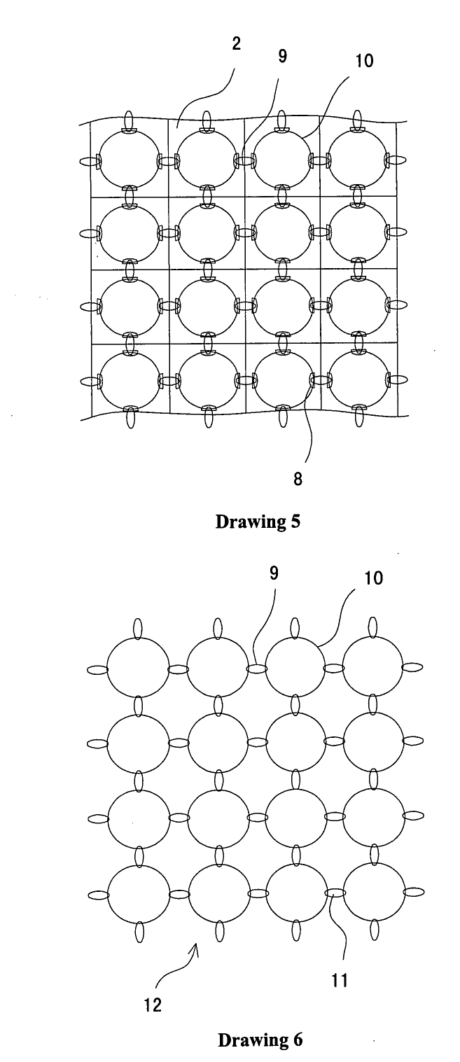

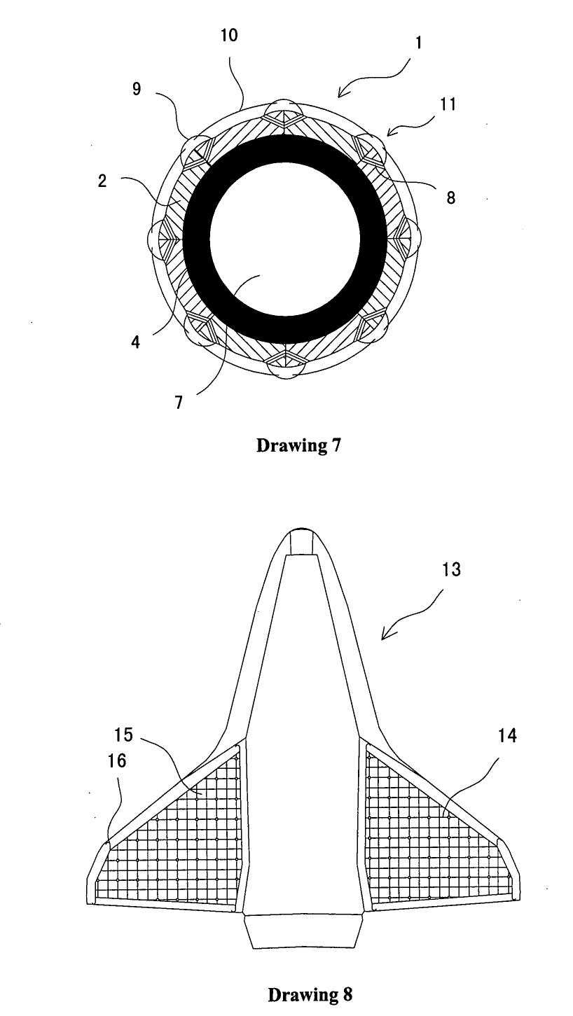

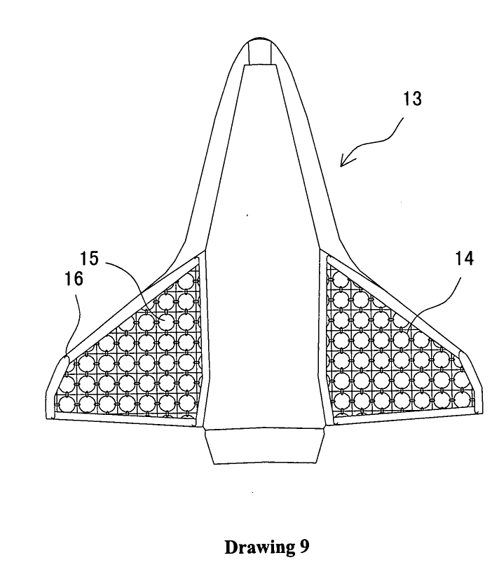

### FIELD OF THE INVENTION

This invention refers to the safety technology in aerospace engineering field. It specifically refers to a technique for preventing the thermal insulating foam from peeling off from the space shuttle and its external tank (ET).

### BACKGROUND OF THE INVENTION

The aerospace engineering technology is an important technique for human to explore the outer space. Presently, the aerospace engineering technology has become one of the important symbols for recognition of advanced developed countries, and manned spacecraft is an effective tool to learn and research the outer space directly. However, the safety issue of the space shuttle has recently become the significant subject attracting high attention of relevant organizations and scientists. As reported, the main reason for the tragedy of the US space shuttle Columbia in 2003 was that the thermal insulating foam chunks fell off and hit the space shuttle's Reinforced Carbon-Carbon(RCC)part, which caused the devastating breach of the space shuttle's skin. When this space shuttle reentered earth's atmosphere, the devastating breach allowed the ultra-temperature air with a temperature more than 5000° F. inside the shuttle, which tore the space shuttle. Since this tragedy, though scientists have adopted some measures and set up new regulations, the peeling off problem of the thermal insulating foam from the space shuttle or its ET has not been resolved effectively, and the hidden hazard still exists.

### SUMMARY OF THE INVENTION

This invention provides a technique for preventing the thermal insulating foam from peeling off from the space shuttle and its external tank (ET), with a purpose to effectively prevent the foam chunks from peeling off by simple and easy way, and thereupon resolves the safety problem resulted from the peeling off of the thermal insulating foam from the space shuttle and its ET.

To reach the above described purpose, this invention follows this technique design: The invention as disclosed herein is a technique for preventing the thermal insulating foam from peeling off from the space shuttle and its external tank (ET) possessing the following characteristics: a high intensity protective net shield designed for the space shuttle or/and the ET, which is made of the high-temperature and high intensity ropes, is installed as one of the following designs:

A. Install the protective net shield directly on the out side of the thermal insulating foam of the space shuttle and its ET by covering the thermal insulating foam while the mesh area of the protective net shield is smaller than the area of the single chunk of heat-insulating-coating foam so that it would prevent the thermal insulating foam chunks falling out from the mesh, and fix the mesh knots onto corresponding thermal insulating foam chunks;

B. Between joint lines of two adjacent polygon thermal insulating foam chunks of the space shuttle and its ET, respectively bind two thermal insulating foam chunks together with a rope through the meshes, and the binding ropes creates at least one binding loop at each joint line; then connect all binding loops of each joint lines of each corresponding thermal insulating foam chunk into a protective loop by the ropes. Connect each protective loop via each binding loop as mesh knots, and thereby form the protective net shield.

Relevant issues regarding the aforesaid technique are explaining as follows:

1. In the above described design, each joint line on each polygon thermal insulating foam chunk has holes for binding purpose which are designed in a vertical way or a sloping way, and two adjacent thermal insulating foam chunks are bound together with ropes through corresponding vertical holes or sloping holes.

2. In the above described design, such protective net shield is in the shape of flake or barrel, and is fixed by hooking its edge on the skin of the space shuttle and its ET.

3. The above described design can be used on the improvement for the traditional space shuttle and its ET by applying this protective net shield technique on the traditional thermal insulating foam or by applying such protective net shield technique on an extra thermal insulating coating outside the traditional thermal insulating coating.

In conclusion, this invention is a safety-protective net shield to prevent the thermal insulating foam from peeling off from the space shuttle and its ET. By fixing the thermal insulating foam of the space shuttle and its ET by way of creating the mesh structure, this technique will prevent the thermal insulating foam from hitting the space shuttle and then creating the cracks while they are peeling off, and will also prevent the thermal insulating foam from peeling off from the space shuttle itself which may cause fatal accident.

By application of above technique designs, this invention has the following advantages and effects compared with present technology:
1. This invention adds a mesh-like protection to the traditional thermal insulating coating of the space shuttle's ET or of the space shuttle itself, which will effectively prevent the thermal insulating foam chunks from peeling off from the space shuttle's ET or from the space shuttle itself, and will improve the safety for the space shuttle's ET and the space shuttle itself. In that way, even if the thermal insulating foam chunks begin to peel off from the ET, they will be covered by the mesh which keeps them from falling off and hitting the space shuttle.
2. This invention is designed basing on a mesh-like protection technique and is easy to operate, feasible, safe and reliable with practical and constructive value. It has a positive effect on the development of the aerospace engineering, especially the safe-flight of the space shuttle.
3. This invention not only provides a safety protection design to the thermal insulating foam of brand new space shuttle and its ET, but also provides an improvement for the thermal insulating foam of used space shuttle and its ET.

### BRIEF DESCRIPTION OF THE DRAWINGS

Drawing 1 is the stereo drawing of the Application Sample 1 space shuttle's ET.

Drawing 2 is the partial enlarged illustration of Attached Drawing 1.

Drawing 3 is the cutaway illustration of Attached Drawing 1.

Drawing 4 is the stereo drawing of the Application Sample 2 space shuttle's ET.

Drawing 5 is the partial enlarged illustration of Attached Drawing 4.

Drawing 6 is the illustration of the protective net shield in Attached Drawing 5.

Drawing 7 is the cutaway illustration of Attached Drawing 4.

Drawing 8 is the stereo drawing of the Application Sample 3 space shuttle's ET.

Drawing 9 is the stereo drawing of the Application Sample 4 space shuttle's ET.

In the above attached drawings: 1. external tank (ET); 2. thermal insulating foam chunks; 3. ropes; 4. skin of fuel tank; 5. protective net shield; 6. mesh knots; 7. fuel room; 8. sloping hole; 9. binding loops; 10. protective loops; 11. mesh knots; 12. protective net shield; 13. space shuttle; 14. protective net shield; 15. thermal insulating foam chunks; 16. hooks.

### DETAILED DESCRIPTION OF APPLICATIONS

The following is the further description of this invention basing on the attached drawings and application samples:

Sample 1: a technique for preventing the thermal insulating foam from peeling off from the space shuttle's ET.

As in the Drawing 1, an ET of the space shuttle 1 mainly provides the fuel for the external orbiter. When the space shuttle, the ET and the external orbiter reach certain height, the orbiter and the ET will separate apart from the space shuttle successively, and the space shuttle will keep on going along its orbit. The ET 1 is in a columnar shape and its head is in a stream-line spire shape as shown in Drawing 1. Order from inside to outside, it is fuel room 7, skin of fuel tank 4, the thermal insulating foam chunks 2, as shown in Drawing 3. In order to prevent the thermal insulating foam falling off from the space shuttle's ET, install the protective net shield 5 directly on the outside of the thermal insulating foam 2 of the ET 1 by covering the thermal insulating foam chunks 2, while the mesh area of the protective net shield 5 is smaller than the area of the single thermal insulating foam chunk 2 so that it would prevent the thermal insulating foam chunks 2 falling out from the mesh, as shown in Drawing 2. As we are concerned, during the launch of the space shuttle, the ET and the external orbiter, the surface temperature of them will be extremely high. The protective net shield 5 has to be made of the high-temperature and high intensity ropes 3 and the ropes 3 compose the mesh structure by connecting each mesh knot 6. The mesh knot is fixed onto corresponding thermal insulating foam chunks 2.

Sample 2: a technique for preventing the thermal insulating foam from peeling off from the space shuttle's ET.

As in the Drawing 4, an ET of the space shuttle 1 mainly provides the fuel for the external orbiter. When the space shuttle, the ET and the external orbiter reach certain height, the orbiter and the ET will separate apart from the space shuttle successively, and the space shuttle will keep on going along its orbit. The ET 1 is in a columnar shape and its head is in a stream-line spire shape as shown in Drawing 4. Order from inside to outside, it is fuel room 7, skin of fuel tank 4, the thermal insulating foam chunks 2, as shown in Drawing 7. In this Application Sample, in order to prevent the thermal insulating foam chunks from peeling off from the space shuttle's ET, between joint lines of two adjacent quadrangular thermal insulating foam chunks 2 respectively bind two thermal insulating foam chunks together with the ropes 3 through the sloping holes 8, and the binding ropes 3 creates one binding loop 9 at each joint line; then connect four binding loops 9 of four joint lines of each corresponding thermal insulating foam chunk 2 into a protective loop 10 by the ropes 3. Connect each protective loop 10 via each binding loop 9 as mesh knots and thereby form the protective net shield 12. The protective net shield 12 is able to bind all thermal insulating foam chunks as a whole by connecting bind loops 9, as shown in Drawing 5, while the bind loops 9 and the protective loops 10 connect to each other to form the protective net shield 12 outside of the thermal insulating foam chunks 2, as shown in Drawing 6. Since the surface temperature of the ET 1 will be extremely high, the protective net shield 5 has to be made of the high-temperature and high intensity ropes 3.

Sample 3: a technique for preventing the thermal insulating foam from peeling off from the space shuttle's ET.

As in the Drawing 8, the thermal insulating foam 15 is installed on the surface of the space shuttle 13. To prevent the thermal insulating foam chunks on the surface of the space shuttle from peeling off, this Application Sample adopts the high intensity protective net shield 14, which could be in the shape of flat or barrel. The shield in barrel shape is suitable for the body of the space shuttle 13 and the shield in flak shape is suitable for certain parts of the space shuttle, e.g. the wings (see Drawing 8). The protective net shield 14 is fixed by hooking its edge on the skin of the space shuttle and its ET. As we are concerned, during the launch of the ET 1, the space shuttle 13 and the orbiter, the surface temperature of them will be extremely high; when the space shuttle 13 reenters earth's atmosphere, its surface temperature will be even higher. Therefore, the ropes have to be made of high-temperature and high intensity materials. The form and structure of protective net shield 14 are same as Application Sample One, and thus the description for such will not be repeated here.

Sample 4: a technique for preventing the thermal insulating foam from peeling off from the space shuttle's ET.

As in the Drawing 9, the thermal insulating foam 15 is installed on the surface of the space shuttle 13. To prevent the thermal insulating foam chunks on the surface of the space shuttle from peeling off, this Application Sample adopts the high intensity protective net shield 14, which could be in the shape of flat or barrel. The shield in barrel shape is suitable for the body of the space shuttle 13 and the shield in flak shape is suitable for certain parts of the space shuttle, e.g. the wings (see Drawing 9). The protective net shield 14 is fixed by hooking its edge on the skin of the space shuttle and its ET. As we are concerned, during the launch of the ET 1, the space shuttle 13 and the orbiter, the surface temperature of them will be extremely high; when the space shuttle 13 reenters earth's atmosphere, its surface temperature will be even higher. Therefore, the ropes have to be made of high-temperature and high intensity materials. The form and structure of protective net shield 14 are same as Application Sample Two, and thus the description for such will not be repeated here.

1. The invention as disclosed herein is a technique for preventing the thermal insulating foam from peeling off from the space shuttle and its external tank (ET) possessing the following characteristics: a high intensity protective net shield designed for the space shuttle or/and the ET, which is made of the high-temperature and high intensity ropes, is installed as one of the following designs:
A. Install the protective net shield directly on the out side of the thermal insulating foam of the space shuttle and its ET by covering the thermal insulating foam while the mesh area of the protective net shield is smaller than the area of the single chunk of heat-insulating-coating foam so that it would prevent the thermal insulating foam chunks falling out from the mesh, and fix the mesh knots onto corresponding thermal insulating foam chunks;
B. Between joint lines of two adjacent polygon thermal insulating foam chunks of the space shuttle and its ET, respectively bind two thermal insulating foam chunks together with a rope through the meshes, and the binding ropes creates at least one binding loop at each joint line; then connect all binding loops of each joint lines of each corresponding thermal insulating foam chunk into a protective loop by the ropes. Connect each protective loop via each binding loop as mesh knots, and thereby form the protective net shield.

2. Pursuant to the description of claim 1, such design possesses the following characteristics: each joint line on each polygon thermal insulating foam chunk has holes for binding purpose which are designed in a vertical way or a sloping way, and two adjacent thermal insulating foam chunks are bound together with ropes through corresponding vertical holes or sloping holes.

3. Pursuant to the description in claim 1, such design possesses the following characteristics: such protective net shield is in the shape of flake or barrel, and is fixed by hooking its edge on the skin of the space shuttle and its ET.
